(19) United States
(12) Patent Application Publication
(10) Pub. No.: US 2003/0144061 A1
(43) Pub. Date: Jul. 31, 2003

(54) Convoluted boot assembly

(76) Inventor: Werner Krude, Neunkirchen-Seelscheid (DE)

Correspondence Address: Robert P. Renke, Suite 205, 28333 Telegraph Road, Southfield, MI, 48034, US

(21) Appl. No.: 10/346,972

(22) Filed: Jan. 17, 2003

(30) Foreign Application Priority Data
Jan. 18, 2002 (DE) 102 01 815.4

(51) Int. Cl. F16D 3/84

(52) U.S. Cl. 464/175

(57) ABSTRACT

A convoluted boot assembly, especially for sealing a constant velocity joint (11) which comprises part of a joint assembly with a stationary component (27) for a motor vehicle and an outer part (13) with an attaching journal (14), an inner part (15) as well as elements (16) for transmitting torque between the inner part (15) and the outer part (13). The convoluted boot assembly comprises a convoluted boot (32) with a first collar (41) for being arranged at the connecting journal (14), with a second collar (43) for being secured to the stationary component (27), as well as a wall which connects the two collars (41, 43) and extends over the constant velocity joint (11). Furthermore, the convoluted boot 32 comprises a bearing assembly (38) for rotatably supporting the convoluted boot 32 at the attaching journal (14), as well as a seal (39) for sealing the convoluted boot (32) relative to the attaching journal (14).

### TECHNICAL FIELD

The invention relates to a convoluted boot assembly for sealing a constant velocity joint which comprises an outer joint part connected to a first shaft journal or to an intermediate shaft, an inner joint part connected to a second shaft journal, as well as elements for transmitting torque between the inner joint part and the outer joint part. The torque transmitting elements angularly movably connect the two shaft journals to one another. One shaft journal is rotatably supported in a carrier structure, and the other shaft journal is capable of being articulated relative to the carrier structure. The convoluted boot assembly is particularly suitable for sealing an inner constant velocity joint of a side shaft of a motor vehicle.

### BACKGROUND OF THE INVENTION

From U.S. Pat. No. 4,516,959, there are known convoluted boots of the foregoing type which, by means of their first collar, are fixed on the first shaft journal in a rotationally fast way, and which, by means of their boot portion, are slidingly positioned on the outer joint part, and which, by means of their second collar, via a plate metal sleeve, are positioned on the second shaft journal in a rotationally fast way.

Because of the constant operation (fulling work), the convoluted boot is subjected to high loads. Boot failure results in the lubricant escaping and in the constant velocity joint running dry. This can then lead to joint failure.

### SUMMARY OF THE INVENTION

It is therefore an object of the present invention to provide a convoluted boot assembly of the initially mentioned type which comprises an advantageous load spectra and thus a longer service life.

The present invention provides a convoluted boot having a first collar for arranging on the articulatable shaft journal, a second collar for securing to the carrier structure, and a wall which connects the two collars and extends over the constant velocity joint whose joint center is positioned between the two collars. The convoluted boot includes a bearing assembly for rotatingly supporting the first collar on the articulatable shaft journal, and a fixing mechanism for fixing the second collar to an annular stationary component of the carrier structure.

This design allows the constant velocity joint with the shaft journal to rotate relative to the convoluted boot assembly, with the latter being connected in a rotationally fast way to the stationary carrier structure of the motor vehicle. For example, the stationary carrier structure may be the outer bearing race of the wheel bearing, which outer bearing race is held in a wheel carrier, or to an annular projection at a differential housing. In this way, when the constant velocity joint is articulated, the convoluted boot is loaded only quasi-statically by circumferentially fixed elongations or shortening of the boot region, with the deformation speed corresponding to the speed of change in the articulation and being independent of the rotational joint speed. There are no dynamic loads combined with a high degree of fulling work per material unit such as they occur with constant velocity joints with rotating convoluted boots.

The present invention is advantageous because the wall of the convoluted boot can be thicker and/or it is possible to use a material with a greater stiffness. As a result, the resistance of the convoluted boot is increased and the service life is prolonged.

According to one embodiment of the invention, the wall connecting the two collars comprises at least one supporting portion for supporting the convoluted boot on the outer part of the constant velocity joint or on the articulatable shaft journal, as well as a folded portion with at least one annular fold for compensating for changes in angle and length resulting from the articulation of the constant velocity joint. The supporting portion stabilizes the convoluted boot and stops the at least one annular fold from coming into contact with the outer part or with the attaching journal or with an intermediate shaft, and grinding thereon when the constant velocity joint is articulated. This prevents the convoluted boot from wearing and failing in the region of contact due to friction effects. Further, when the joint is in an aligned condition, the supporting portion can either be arranged at a distance from the outer part of the constant velocity joint and, respectively, the attaching journal, or it can be in constant contact with these components.

According to a first variant of the convoluted boot assembly, a first supporting portion is arranged so as to adjoin the second collar and comprises a substantially spherical inner face which can be moved into sliding contact with a correspondingly spherical outer face of the outer part. In this way, the convoluted boot is rotatably supported on the outer part, so that it is always held in a defined position. The supporting portion preferably comprises a plurality of continuous annular ribs by means of which the convoluted boot can be sealed relative to the outer joint part. The ribs effectively seal lubricant in the joint interior relative to the annular chamber between the convoluted boot and the outer joint part. When the constant velocity joint is in operation, the ribs at the spherical inner face of the convoluted boot reduce the size of the friction face to a minimum. This embodiment has a further advantage in that lubricant can be collected in the annular grooves formed between each two adjoining ribs, as a result of which the wear in the contact area is reduced.

According to a second variant of the convoluted boot assembly, a second supporting portion is arranged so as to adjoin the first collar and so as to be supportable on a region of transition between the outer part of the constant velocity joint and the articulatable attaching journal. The supporting portion is preferably provided in the form of a thickened inner annular region. When the constant velocity joint is in the aligned condition, there may exist a gap between the supporting portion in the form of an annular thickening and the outer part and attaching journal respectively, so that there can be no wear due to friction contact. When the joint is articulated, the wall of the convoluted boot is supported by means of the thickened annular region on the outer part and the attaching journal respectively, so that the at least one fold is held at a distance from the constant velocity joint.

In another embodiment, the first collar is provided with sealing members for sealing the first collar relative to the articulatable shaft journal.

In a further embodiment, the bearing and the sealing members form one unit. The bearing-and-sealing unit comprises a common outer ring which is firmly connected to the convoluted boot, a common inner ring to be secured to the attaching journal, rolling-contact members, and a seal. The seal can be a radial shaft sealing ring which is arranged so as to axially adjoin the rolling contact members between the outer ring and the inner ring. A cage for holding the rolling contact members may also be provided. According to a further embodiment, the first collar, on its radial inside, comprises an annular recess which axially holds the bearing-and-sealing unit and the convoluted boot, from the outside, is held by a clamp band on the bearing-and-sealing unit. By providing the bearing and the seal in the form of one unit, assembling the convoluted boot assembly is made easier. After the bearing-and-sealing unit has been pressed on to the attaching journal, the convoluted boot is positioned on same by way of its recess. Finally, the convoluted boot is fixed at the first collar by tensioning the clamp band on the bearing-and-sealing unit.

According to a further embodiment, the second collar is secured by means of a clamp band on a plate metal sleeve which can be pressed directly on to the annular component of the carrier structure. If the supporting portion is arranged at the first collar, the plate metal sleeve can be spherical and wide enough for it to extend, at a distance, at least partially over the outer joint part.

According to another embodiment, the inner joint part is connected to a wheel hub in a rotationally fast way and the outer joint part comprises an attaching journal for being connected to a side shaft. This permits the axial distance between the joint center and wheel hub to be minimized, so that it is possible, for operational purposes, to use a long side shaft with small articulation angles. Furthermore, this embodiment is advantageous because it permits interior volume of the boot, and corresponding amount of grease for the joint, to be minimized.

Furthermore, the present invention provides a joint assembly at a motor vehicle, having a convoluted boot assembly of the above-described type.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiment illustrated in greater detail in the accompanying drawings and described below by way of examples of the invention.

In the drawings:

FIG. 1 is a longitudinal section through a first embodiment of a convoluted boot assembly provided at a unit for supporting a wheel of a motor vehicle.

FIG. 2 shows a second embodiment of a convoluted boot assembly provided at a unit for supporting a wheel of a motor vehicle.

### DETAILED DESCRIPTION OF THE INVENTION

While the present invention is described in connection with a convoluted boot assembly in relation to a wheel assembly, the present invention may be adapted and utilized in any environment wherein a convoluted boot is desired to protect and seal a connection between two articulated shafts such as a constant velocity joint connection. Thus, the specific parameters and components described below for one constructed embodiment are included as examples only and are not meant to be limiting.

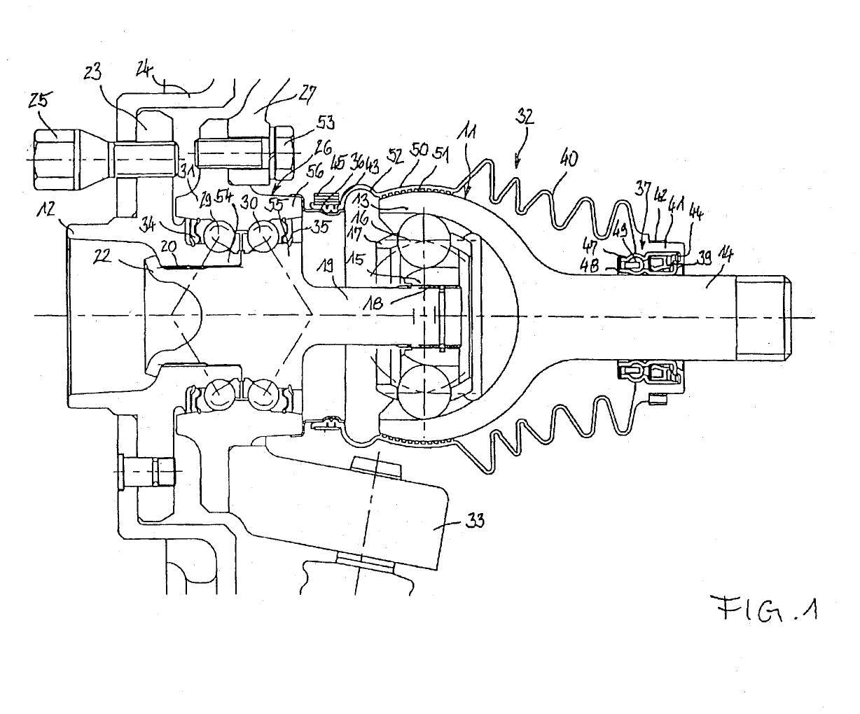

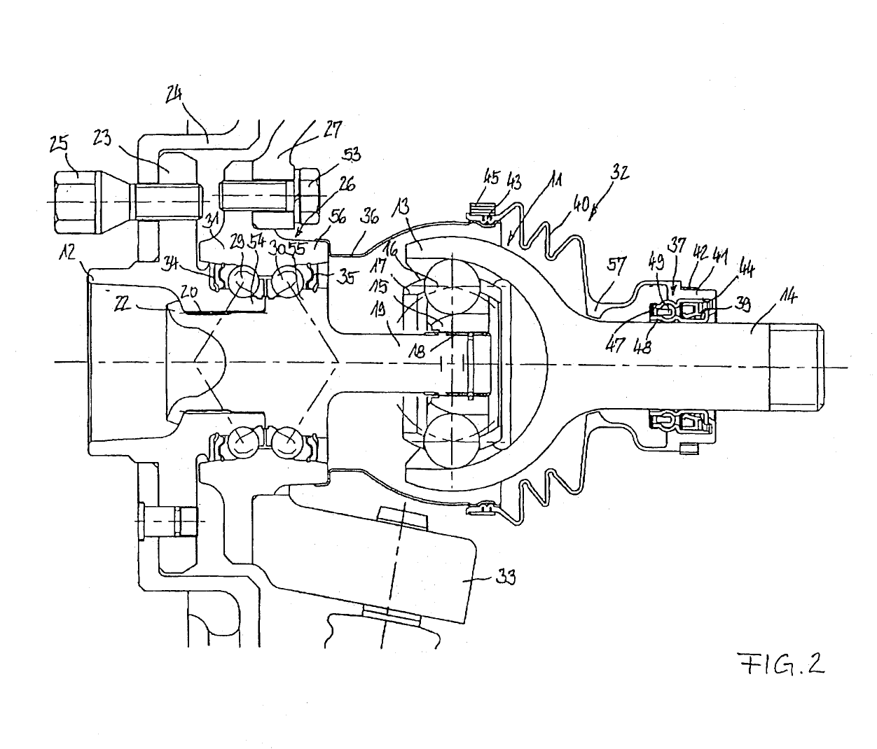

FIGS. 1 and 2 will be described jointly below. A longitudinal section shows a unit for supporting a driven wheel of a motor vehicle. A constant velocity joint 11 comprises an outer part 13 with a first shaft journal 14 for being attached to a side shaft, an inner part 15, balls 16 for transmitting torque from the outer part 13 to the inner part 15, as well as a cage 17 for holding the balls 16 in a common plane. Via shaft toothing 18, a second shaft journal 19 inserted into a bore is connected in a rotationally fast way to the inner part 15. By means of further shaft toothing 20, the second shaft journal 19 is axially connected in a rotationally fast way to a wheel hub 12 via a beading 22. The wheel hub 12 comprises a flange 23 to which there is connected a brake disc 24 by means of bolts 25. The unit consisting of the wheel hub 12 and the second shaft journal 19 is rotatably supported by a wheel bearing 26 in a wheel carrier 27. The wheel bearing 26 comprises two inner bearing races 54, 55, two rows of rolling contact members 29, 30 and an outer bearing race 31. The one inner bearing race 55 forms part of the joint journal 19 and the other inner bearing ring 54 forms part of the wheel hub 12. The outer bearing race 31 is connected by bolts 53 to the wheel carrier 27 which is supported by a guiding joint 33 to a transverse steering arm (not shown in greater detail). Annular chambers between the joint journal 19 and the outer bearing race 31 and between the wheel hub 12 and the outer bearing race 31 are axially sealed towards the outside by two sealing assemblies 34, 35 each consisting of a sealing element and a plate metal element.

On the side of the constant velocity joint 11, the outer bearing race 31, on its outside, comprises a holding portion 56 to which there is attached a plate metal sleeve 36. A convoluted boot 32 is secured to the plate metal sleeve 36 on the one hand, extends over the constant velocity joint 11, and is rotatably supported on the first shaft journal 14 on the other hand. The convoluted boot 32 serves to seal the constant velocity joint 11, and prevents lubricant from escaping from the interior and dirt from reaching the interior.

The convoluted boot 32 comprises a folded portion 40, a first collar 41 and a second collar 43. The first collar 41 has been slipped over a bearing/sealing unit 37 comprising a bearing assembly 38 and a sealing mechanism 39. The bearing/sealing unit 37 comprises an outer ring 47 and an inner ring 48, and in the interior between the outer ring 47 and the inner ring 48, there are arranged axially adjoining rolling contact members 49 held in a cage, as well as a radial shaft sealing ring 39.

The first collar 41, on its radial inside, comprises an annular recess 44 for receiving the bearing/sealing unit 37. The first collar 41 of the convoluted boot 32 embraces the bearing/sealing unit 37 and is secured thereto by means of a clamp band 42. The second collar 43 embraces the plate metal sleeve 36 and secured thereto by means of a clamp band 45. Together, the sleeve 36 and the clamp band 42 comprise a fixing mechanism between the convoluted boot 32 and the stationary component 56 of the carrier structure. Other means for securing the boot collar 43 to the plate metal sleeve 36 are also contemplated.

In FIG. 1, the folded portion 40 of the convoluted boot 32 is followed by a supporting portion 50 which is in sliding contact with the outer part 13 of the constant velocity joint 11. If viewed in the longitudinal section, the supporting portion 50, in the region adjoining the second collar 43, comprises a wall in the shape of a spherical portion with a plurality of inner annular ribs 51, which wall is adapted to the approximately spherical outer face of the outer part 13. The ribs 51 support the convoluted boot 32 on the outer part 13 in such a way that the supporting portion 50 is in supporting contact with the outer part 13 even when the constant velocity joint 11 is articulated. Between the annular ribs 51 serving as lubricant seals, there are formed grooves which serve as lubricant chambers. Between the supporting portion 50 and the second collar 43, there is provided a bead-shaped fold 52 which can be entered by the outer part 13. In this way, it is ensured that the contact face between the supporting portion 50 and the outer part 13 is always lubricated when the constant velocity joint is articulated, which has a friction-reducing effect. Between the supporting portion 50 and the first collar 41, the folded portion 40 comprises a plurality of folds which serve to compensate for changes in length and angle. resulting from angular movements of the constant velocity joint 11. Because the convoluted boot 32 is supported by means of the supporting portion 50 on the outer part 13, it is ensured that the folds of the boot portion 40 comprise a distance relative to the outer part 13 and to the attaching journal 14 respectively, even when the constant velocity joint 11 is in an articulated condition.

In FIG. 2, towards the first shaft journal 14, the folded portion 40 of the convoluted boot 32, is followed by a supporting portion 57 in the shape of one single continuous inner thickening which is radially spaced from the shaft journal 14, but which, at small articulation angles, is able to come into supporting contact with the shaft journal 14 and with the outer joint part 13 respectively, so that the continuous annular folds 40 of the convoluted boot portion are kept free from contacting the outer joint part 13. Among other things, this is ensured by the plate metal sleeve 36, in this embodiment, being very much wider and spherically extending over the outer joint part 13. The no-contact conditions between the plate metal sleeve 36 and the outer joint part 13 are maintained when the constant velocity joint 11 carries out angular movements. Because the convoluted boot 32, by means of its second collar 43, is secured to the free end of the plate metal sleeve 36 and because the folded portion 40 directly adjoins the second collar 43, it is ensured that, even when the constant velocity joint 11 is articulated, the folds of the folded portion 40 maintain a distance from the outer part 13. In this embodiment, lubricant reaches the annular space between the outer joint part and the convoluted boot.

While the invention has been described in connection with one or more embodiments, it should be understood that the invention is not limited to those embodiments. Thus, the invention covers all alternatives, modifications, and equivalents as may be included in the spirit and scope of the appended claims.

What is claimed is:

1. A convoluted boot assembly for sealing a constant velocity joint which comprises an outer joint part connected to a first shaft and an inner joint part connected to a second shaft, wherein one of the shafts is rotatably supported in a carrier structure, and the other shaft is capable of being articulated relative to the carrier structure, the assembly comprising:
a convoluted boot (32) having a first collar (41) for being arranged on the articulatable shaft (14), a second collar (43) for being secured to the carrier structure, and a wall which connects the first and second collars and extends over the constant velocity joint (11) whose joint center is positioned between the two collars (41, 43);
a bearing assembly (38) for rotatingly supporting the first collar (41) on the articulatable shaft (14); and
a fixing mechanism for fixing the second collar (43) to an annular stationary component (56) of the carrier structure.

2. A convoluted boot assembly according to claim 1, comprising a seal (39) for sealing the first collar (41) relative to the articulatable shaft (14), the seal (39) being arranged at the first collar (41).

3. A convoluted boot assembly according to claim 1, wherein the wall connecting the first and second collars (41, 43) comprises at least one supporting portion (50, 57) for supporting the convoluted boot (32) on the outer part (13) of the constant velocity joint (11) or on the articulatable shaft (14).

4. A convoluted boot assembly according to claim 1, wherein the wall connecting the first and second collars (41, 43) comprises a folded portion (40) with at least one annular fold for compensating for changes in angle or length resulting from articulation of the constant velocity joint (11).

5. A convoluted boot assembly according to claim 3, wherein the supporting portion (50) is arranged so as to adjoin the second collar (43) and comprises an inner face which can be brought into sliding contact with a spherical outer face of the outer part (13).

6. A convoluted boot assembly according to claim 3, wherein the supporting portion (50) comprises a plurality of continuous annular ribs (51) for supporting the convoluted boot (32) on the outer part (13).

7. A convoluted boot assembly according to claim 3, wherein the supporting portion (57) is arranged so as to adjoin the first collar (41) and can be supported on the articulatable shaft (14) or on an outer face of the outer joint part (13).

8. A convoluted boot assembly according to claim 7, wherein the supporting portion (57) is provided in the form of an annular inner thickening.

9. A convoluted boot assembly according to claim 2, wherein the bearing assembly (38) and the seal (39) form a bearing-and-sealing unit (37).

10. A convoluted boot assembly according to claim 9, wherein the bearing-and-sealing unit (37) comprises a common outer ring (47) to which the first collar (41) is secured, a common inner ring (48) which is slipped on to the first shaft (14), rolling contact members (49) and a seal (39).

11. A convoluted boot assembly according to claim 10, wherein the rolling contact members (49) are held in a cage.

12. A convoluted boot assembly according to claim 9, wherein the first collar (41), on its inside, comprises an annular recess (44) in which the bearing-and-sealing unit (37) is held axially, and the first collar (41) is secured on said annular recess (44) by a clamp band (42).

13. A convoluted boot assembly according to claim 1, wherein the second collar (43) is secured by a clamp band (45) on a plate metal sleeve (36) which plate metal sleeve can be pressed directly on to the annular component (56) of the carrier structure.

14. A joint assembly for a motor vehicle, comprising:
a constant velocity joint having an outer joint part connected to a first shaft and an inner joint part connected to a second shaft, wherein the second shaft is rotatably supported in a carrier structure, and the first shaft is capable of being articulated relative to the carrier structure;
a convoluted boot (32) having a first collar (41) for being arranged on the first shaft (14), a second collar (43) for being secured to the carrier structure, and a wall which connects the first and second collars and extends over the constant velocity joint (11) whose joint center is positioned between the two collars;
a bearing assembly (38) for rotatingly supporting the first collar (41) on the first shaft (14); and
a fixing mechanism for fixing the second collar (43) to an annular stationary component (56) of the carrier structure.

15. A joint assembly according to claim 14, comprising a seal (39), at the first collar, for sealing the first collar (41) relative to the first shaft (14).

16. A joint assembly according to claim 14, wherein the wall connecting the first and second collars (41, 43) comprises at least one supporting portion (50, 57) for supporting the convoluted boot (32) on the outer part (13) of the constant velocity joint (11) or on the first shaft (14).

17. A joint assembly according to claim 14, wherein wall connecting the first and second collars (41, 43) comprises a folded portion (40) with at least one annular fold for compensating for changes in angle and length resulting from articulation of the constant velocity joint (11).

18. A joint assembly according to claim 16, wherein the supporting portion (50) is arranged so as to adjoin the second collar (43) and comprises an inner face which is in sliding contact with a spherical outer face of the outer part (13).

19. A joint assembly according to claim 16, wherein the supporting portion (50) comprises a plurality of continuous annular ribs (51) for supporting the convoluted boot (32) on the outer part (13).

20. A joint assembly according to claim 16, wherein the supporting portion (57) is arranged so as to adjoin the first collar (41) is supported on the first shaft (14) or on an outer face of the outer joint part (13).

21. A joint assembly according to claim 20, wherein the supporting portion (57) is provided in the form of an annular inner thickening.

22. A joint assembly according to claim 14, wherein the bearing assembly (38) and the seal (39) form a bearing-and-sealing unit (37).

23. A joint assembly according to claim 22, wherein the bearing-and-sealing unit (37) comprises a common outer ring (47) to which the first collar (41) is secured, a common inner ring (48) which is slipped on to the first shaft (14), rolling contact members (49) and a seal (39).

24. A joint assembly according to claim 23, wherein the rolling contact members (49) are held in a cage.

25. A joint assembly according to claim 22, wherein the first collar (41), on its inside, comprises an annular recess (44) in which the bearing-and-sealing unit (37) is held axially, and the first collar (41) is secured on said annular recess (44) by a clamp band (42).

26. A joint assembly according to claim 14, wherein the second collar (43) is secured by a clamp band (45) on a plate metal sleeve. (36) which plate metal sleeve is pressed directly on to the annular component (56) of the carrier structure.

27. A joint assembly according to claim 14, wherein the inner joint part (15) is connected to a wheel hub (12) in a rotationally fast way, and the outer joint part (13) comprises a connecting journal (14) for being connected to a side shaft.
